(19) United States
(12) Patent Application Publication
(10) Pub. No.: US 2017/0344121 A1
(43) Pub. Date: Nov. 30, 2017

(54) SYSTEM AND METHOD FOR COMPLETING A CALL UTILIZING A HEAD-MOUNTED DISPLAY AND A COMMUNICATION DEVICE

(71) Applicant: MOTOROLA SOLUTIONS, INC, SCHAUMBURG, IL (US)

(72) Inventors: ALEJANDRO G. BLANCO, FORT LAUDERDALE, FL (US); LANTING L. GARRA, SUNRISE, FL (US); MELANIE A. KING, HOLLYWOOD, FL (US); CRAIG SIDDOWAY, DAVIE, FL (US); BERT VAN DER ZAAG, GOLDEN, CO (US); PATRICK KOSKAN, LAKE WORTH, FL (US)

(21) Appl. No.: 15/165,463

(22) Filed: May 26, 2016

(51) Int. Cl. G06F 3/01; H04W 4/10; G06F 1/16; H04L 29/06; H04M 1/60; H04W 76/02; H04M 3/42; H04B 1/3827

(52) U.S. Cl. CPC G06F 3/017; H04W 76/02; H04W 4/10; H04M 3/42093; G06F 1/163; H04L 65/4069; H04M 1/6066; G06F 3/012; H04B 2001/3866

(57) ABSTRACT

A user desires to complete a call utilizing a head-mounted display and a communication device. A call-initiating event is detected at the communication device. In response to the call-initiating event, an intended call recipient is identified utilizing the head-mounted display. A call is then initiated with the intended call recipient utilizing the communication device.

### BACKGROUND OF THE INVENTION

For first responders, time is of the essence. There is an ever-increasing desire to decrease the time it takes for first responders to perform any useful task.

One task that is often critical for first responders is communication. Delayed or inaccurately connected calls can lead to adverse consequences for the first responder and others, including injuries and death.

One issue for first responders is that their hands can be in use for other, often vital activities when a call needs to be made. This can slow down their ability to place a call, in particular if they need to key in the number of an intended call recipient on their communication device.

An additional problem for first responders is when they have to divert their gaze from an emergency situation to their communication device in order to select an intended call recipient. If they divert their attention from the emergency situation they can put themselves or others in peril, but if they do not look at their communication device they can call an unintended party or not make a call at all.

Therefore a need exists for an improved method, device, and system that allows a first responder to accurately and quickly communicate with an intended call recipient without having to divert their gaze from an emergency situation.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a depiction of a first responder user wearing a wireless computing device and a head-mounted display in accordance with an exemplary embodiment.

FIG. 2 is a system diagram illustrating an infrastructure wireless network for completing a call utilizing a head-mounted display and a communication device in accordance with an exemplary embodiment.

FIG. 3 is a device diagram showing a device structure of the wireless computing device of FIG. 1 in accordance with an exemplary embodiment.

FIG. 4 illustrates a flow chart setting forth process steps for completing a call utilizing a head-mounted display and a communication device in accordance with an exemplary embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

An exemplary embodiment provides a method for completing a call utilizing a head-mounted display and a communication device. The communication device detects a call-initiating event. In response to the call-initiating event, a camera connected to the head-mounted display determines what or who the user is looking at and utilizes this information to identify an intended call recipient. A call is initiated with the intended call recipient utilizing the communication device.

Disclosed is an improved method, device, and system for completing a call utilizing a camera connected to a head-mounted display and a communication device. In a first exemplary embodiment, a call-initiating event, such as the pressing of a push-to-talk button, is detected. If the user is connected to a head-mounted display, and intended call recipient (or recipients) is identified and a call is initiated with the intended call recipient. In a second exemplary embodiment, an intended recipient (or recipients) is selected, and network resources are allocated for each of the intended recipients, preferably as they are selected. The user(s) is then called when a call-initiating event occurs.

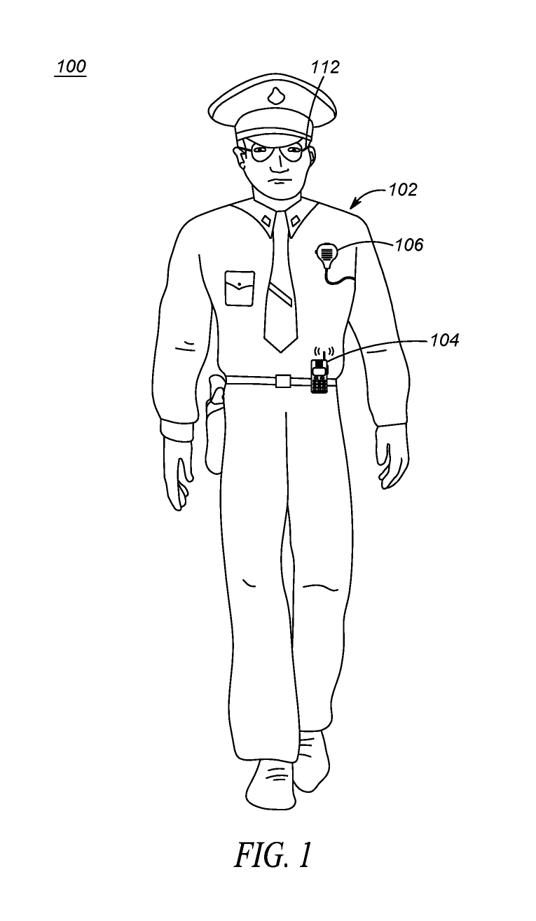

Referring now to the figures, and in particular FIG. 1, a system diagram illustrates a system 100 of wireless and/or wired devices that a user 102 (illustrated in FIG. 1 as a first responder) may wear, including a primary wireless computing device 104 (depicted in FIG. 1 as a mobile radio) used for narrowband and/or broadband communications, a remote speaker microphone (RSM) 106, and a pair of smart glasses 112.

Wireless computing device 104 may be any wireless device used for infrastructure-supported media (e.g., voice, audio, video, etc.) communication via a long-range wireless transmitter (e.g., in comparison to a short-range transmitter such as a Bluetooth, Zigbee, or NFC transmitter) and/or transceiver with other mobile radios in a same or different group of mobile radios as wireless computing device 104. The long-range transmitter may have a transmit range on the order of miles, e.g., 0.5-50 miles, or 3-20 miles.

In order to communicate with other elements of wireless computing device 104, wireless computing device 104 may contain one or more internal electronic busses for communicating with sensors integrated in or on the wireless computing device 104 itself, may contain one or more physical electronic ports (such as a USB port, an Ethernet port, an audio jack, etc.) for direct electronic coupling with another wireless accessory device, and/or may contain a short-range transmitter (e.g., in comparison to the long-range transmitter such as a LMR or Broadband transmitter) and/or transceiver for wirelessly coupling with another wireless accessory device. The short-range transmitter may be a Bluetooth, Zigbee, or NFC transmitter having a transmit range on the order of 0.01-100 meters, or 0.1-10 meters.

Accessory devices 106 and 112 preferably communicate with wireless computing device 104 via their own direct electronic coupling or short-range transmitter and/or transceivers.

For example, RSM 106 may act as a remote microphone that is closer to user first responder's 102 mouth. A speaker may also be provided in RSM 106 such that audio and/or voice received at wireless computing device 104 is transmitted to RSM 106 and played back closer to user first responder's 102 ear.

Smart glasses 112 preferably include a camera, an eye tracking module, and head orientation sensors. Smart glasses 112 can support augmented reality, where the real world can still be seen, and can alternately support virtual reality, where the user is presented a completely controlled view. Smart glasses 112 preferably maintain a bi-directional connection with wireless computing device 104 and provide an always-on or on-demand video feed pointed in a direction of the gaze of user first responder 102, and in a filtered or un-filtered state, back to wireless computing device 104. Smart glasses 112 may also provide a personal display via a projection mechanism integrated into smart glasses 112 for displaying information such as text, images, or video received from wireless computing device 104. In some embodiments, an additional user interface mechanism such as a touch interface may be provided on smart glasses 112 that allows user first responder 102 to interact with the display elements displayed on smart glasses 112.

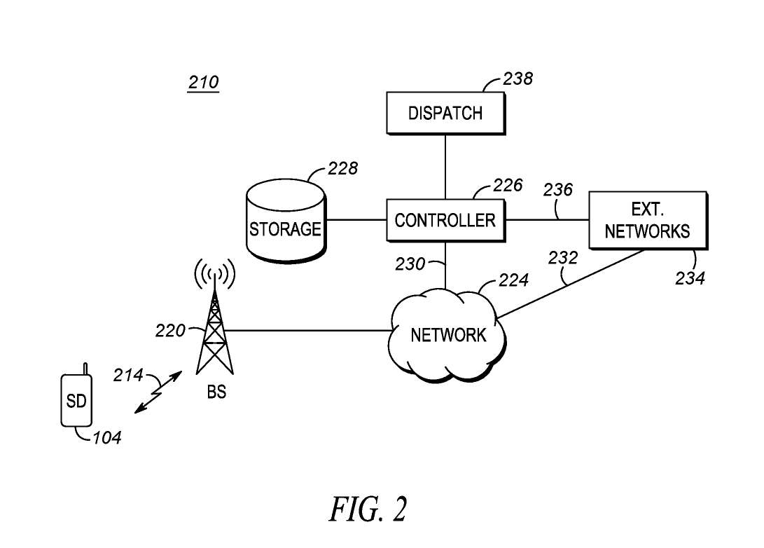

FIG. 2 depicts a system diagram illustrating an infrastructure wireless communication network for supporting wireless communication device for completing a call utilizing a head-mounted display and a communication device in accordance with an exemplary embodiment. In particular, FIG. 2 illustrates an infrastructure wireless communications network 210 including a wireless computing device 104, fixed terminal 220 (e.g., a repeater, base transceiver station (BTS) or eNodeB, hereinafter referred to as a base station (BS)), wireless link(s) 214, backhaul network 224, radio controller device 226, storage 228, communications connections 230, 232, 236, dispatch console 238, and external networks 234. BS 220 preferably has at least one radio transmitter covering a radio coverage cell (not shown). One or several mobile radios within radio coverage of BS 220 may connect to BS 220 using a wireless communication protocol via wireless link(s) 214. Wireless computing device 104 may communicate with other mobile radios and with devices in infrastructure 210 (such as dispatch console 238), and perhaps other devices accessible external networks, using a group communications protocol over wireless link(s) 214. Wireless link(s) 214 may include one or both of an uplink channel and a downlink channel, and may include one or more physical channels or logical channels. Wireless link(s) 214 may implement, for example, a conventional or trunked land mobile radio (LMR) standard or protocol such as ETSI Digital Mobile Radio (DMR), Project 25 (P25) standard defined by the Association of Public Safety Communications Officials International (APCO), or other radio protocols or standards. In other embodiments, wireless link(s) 214 may additionally or alternatively implement a Long Term Evolution (LTE) protocol including multimedia broadcast multicast services (MBMS), an open mobile alliance (OMA) push to talk (PTT) over cellular (OMA-PoC) standard, a voice over IP (VoIP) standard, or a PTT over IP (PoIP) standard. Other types of wireless protocols could be implemented as well.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) protocol. Mobile radios in RANs such as those set forth above send and receive media streams (encoded portions of voice, audio, and/or audio/video streams) in a call in accordance with the designated protocol.

In accordance with an exemplary embodiment, wireless link 214 is established between wireless computing device 104 and BS 220 for transmission of a device-sourced call including a media stream (e.g., formatted bursts, packets, messages, frames, etc. containing digitized audio and/or video representing a portion of an entire call, among other possible signaling and/or other payload data) to one or more target devices (not shown), perhaps belonging to a same subscribed group or talkgroup of mobile radios as source wireless computing device 104.

Wireless computing device 104 may be configured with an identification reference (such as an International Mobile Subscriber Identity (IMSI) or MAC address) which may be connected to a physical media (such as a Subscriber Identity Module (SIM) card). Wireless computing device 104 may be a group communications device, such as a push-to-talk (PTT) device, that is normally maintained in a monitor only mode, and which switches to a transmit-only mode (for half-duplex devices) or transmit and receive mode (for full-duplex devices) upon depression or activation of a PTT call button. The group communications architecture in infrastructure wireless communications network 210 allows a single mobile radio, such as wireless computing device 104, to communicate with one or more group members (not shown) associated with a particular group of mobile radios at the same time.

Although only a single controller device 226 is illustrated in FIG. 2, more than one controller device 226 may be used and/or a distributed controller device 226 may be used that divides functions across multiple devices, perhaps for load balancing reasons. Finally, while storage 228 is illustrated as directly coupled to controller device 226, storage 228 may also be disposed remote from controller device 226 and accessible to controller device 226 via one or more of network 224 and/or external networks 234.

Controller device 226 may be, for example, a call controller, PTT server, zone controller, evolved packet core (EPC), mobility management entity (MME), radio network controller (RNC), base station controller (BSC), mobile switching center (MSC), site controller, Push-to-Talk controller, or other network device for controlling and distributing calls amongst mobile radios via respective BSs. Controller device 226 may further be configured to provide registration, authentication, encryption, routing, and/or other services to BS 220 so that mobile radios operating within its coverage area may communicate with other mobile radios in the communications system.

BS 220 may be linked to controller device 226 via one or both of network 224 and communications connection 230. Network 224 may comprise one or more routers, switches, LANs, WLANs, WANs, access points, or other network infrastructure. For example, controller device 226 may be accessible to BS 220 via a dedicated wireline or via the Internet. In one example, BS 220 may be directly coupled to controller device 226 via one or more internal links under control of a single communications network provider.

Storage 228 may function to store PCIE information reported from mobile radios for evidentiary purposes, for access by a dispatcher at dispatch console 238, for access by other mobile radios via BS 220 and/or other BSs (not shown), or for other reasons.

The one-to-many group communication structure may be implemented in communications network 210 in a number of ways and using any one or more messaging protocols, including multiple unicast transmissions (each addressed to a single group member wireless computing device), single multicast transmissions (addressed to a single group or multiple groups), single broadcast transmissions (the broadcast transmission perhaps including one or more group identifiers that can be decoded and matched by the receiving wireless computing devices), or any combination thereof.

External networks 234 may also be accessible to BS 220 (and thus wireless computing device 104) via network 224 and communications connection 232 and/or controller device 226 and communications connections 230, 236. External networks 234 may include, for example, a public switched telephone network (PSTN), the Internet, or another wireless service provider's network, among other possibilities.

Dispatch console 238 may be directly coupled to controller device 226 as shown, or may be indirectly coupled to controller device 226 via one or more of network 224 and external networks 234, or some other network device in network 224.

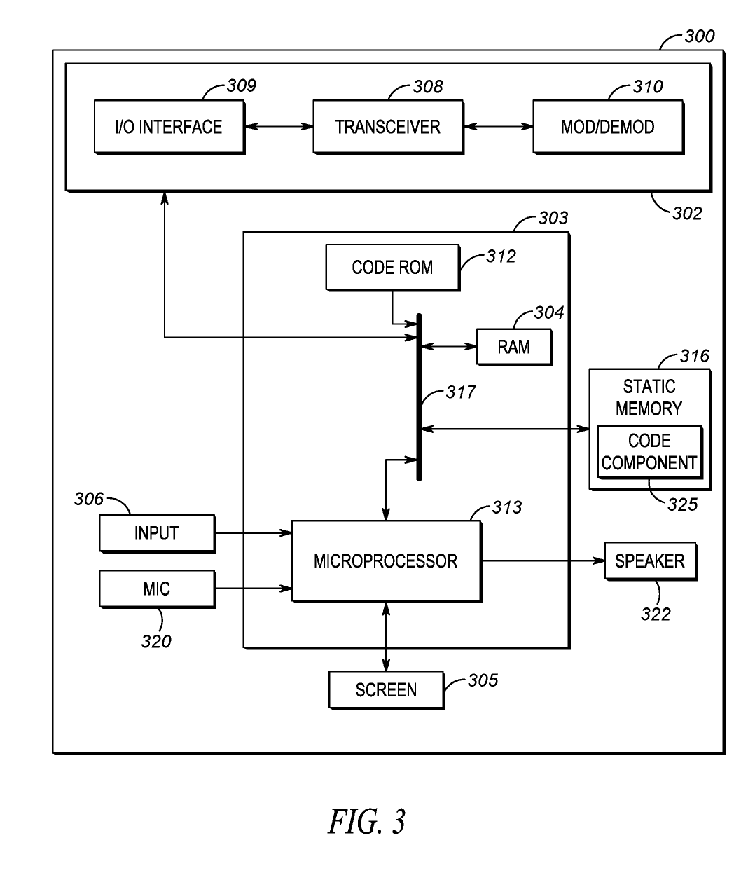

FIG. 3 depicts a schematic diagram of a wireless computing device 300 according to an exemplary embodiment of the present disclosure. Wireless computing device 300 may be, for example, the same as or similar to the wireless computing device 104 of FIGS. 1 and 2. As shown in FIG. 3, wireless computing device 300 includes a communication unit 302 coupled to a common data and address bus 317 of a processing unit 303. Wireless computing device 300 may also include an input unit (e.g., keypad, pointing device, etc.) 306 and a display screen 305, each coupled to be in communication with processing unit 303.

A microphone 320 preferably captures audio from a user that is further vocoded by processing unit 303 and transmitted as voice stream data by communication unit 302 to other mobile radios and/or other devices via network 224. A communications speaker 322 reproduces audio that is decoded from voice streams of voice calls received from other mobile radios and/or from an infrastructure device via communication unit 302.

Processing unit 303 may include a code Read Only Memory (ROM) 312 coupled to common data and address bus 317 for storing data for initializing system components. Processing unit 303 may further include an electronic microprocessor 313 coupled, by common data and address bus 317, to a Random Access Memory (RAM) 304 and a static memory 316.

Communication unit 302 may include one or more wired or wireless input/output (I/O) interfaces 309 that are configurable to communicate with networks 224 via BSs 220, with other mobile radios, and/or with accessory devices 106 and 112.

Communication unit 302 may include one or more wireless transceivers 308, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, and/or other similar type of wireless transceiver configurable to communicate via a wireless radio network. Communication unit 302 may additionally or alternatively include one or more wireline transceivers 308, such as an Ethernet transceiver, a Universal Serial Bus (USB) transceiver, a Tip, Ring, Sleeve (TRS) connection, a Tip, Ring, Ring, Sleeve (TRRS) connection, or similar transceiver configurable to communicate via a twisted pair wire, a coaxial cable, a fiber-optic link, an audio jack, or a similar physical connection to a wireline network. Transceiver 308 is also preferably coupled to a combined modulator/demodulator 310.

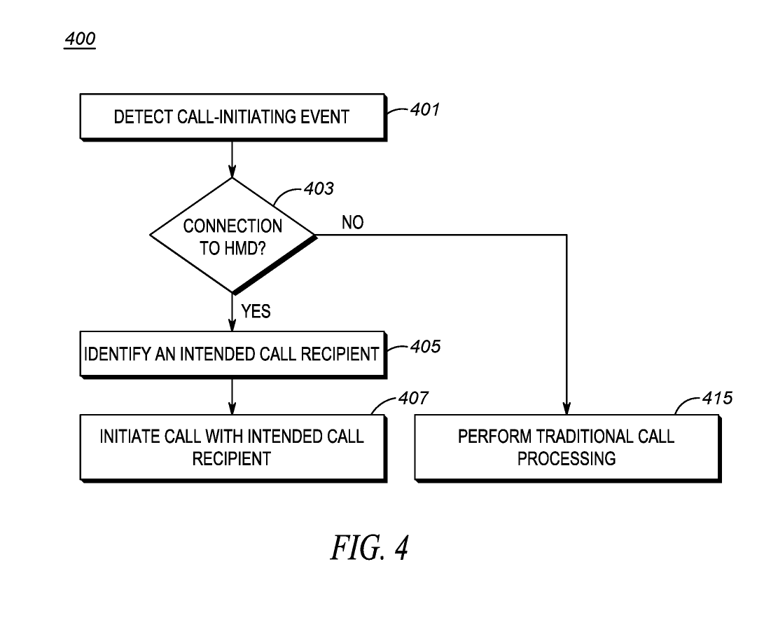

Microprocessor 313 preferably has ports for coupling to input unit 306 and microphone unit 320, and to display screen 305 and speaker 322. Static memory 316 may store operating code for microprocessor 313 that, when executed, performs one or more of the wireless computing device processing, transmitting, and/or receiving steps set forth in FIG. 4 and accompanying text. Static memory 316 may also store, permanently or temporarily, data associated with an intended call recipient, such as a phone number or the like.

Static memory 316 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, to name a few.

FIG. 4 illustrates a flow chart 400 setting forth process steps for completing a call utilizing a head-mounted display and a communication device in accordance with an exemplary embodiment.

The communication device detects (401) a call-initiating event. In an exemplary embodiment, the detecting of a call-initiating event comprises detecting that a call button, such as a Push-To-Talk (PTT) button on a mobile radio, is pressed. In a further exemplary embodiment, the call button can be a dial button on a mobile phone.

The step of detecting can also be accomplished by detecting a predefined gesture. For example, a user can make a predefined gesture, such as placing two fingers on a table, in order to indicate that the user wants to initiate a call. This gesture can be detected by a camera in the head-mounted display or by another device coupled to the communication device, and video analytic software can be used to detect the hand positions.

The step of detecting can also be accomplished by detecting a predefined object. For example, the object could be a physical symbol rendered on a visor or the like that is a representation of a predefined object that indicates that the user desires to initiate a call. For example, the object could be a representation of a two-way radio. When this object is selected, the communication device detects that the user desires to initiate a call. This object detection may be done by the head-mounted display, or alternately can be done by another device coupled to the communication device.

Upon detecting a call-initiating event, the communication device determines (403) if it is operably coupled to a head-mounted display. If the communication device is not connected to a head-mounted display, the communication device performs (415) traditional call processing.

If the communication device determines at step 403 that it is connected to a head-mounted display, the head-mounted display identifies (405) an intended call recipient. In a first exemplary embodiment, an intended call recipient is identified as the person that the user of the head-mounted display is looking at. Alternately, the intended call recipient can be a person associated with an icon or avatar that the user of the head-mounted display is looking at. The step of identifying can be accomplished utilizing location tracking. In this exemplary embodiment, the step of identifying an intended call recipient is accomplished utilizing the head orientation of the user and the location of other system users.

In an alternate exemplary embodiment, the user of the head-mounted display may be looking at a first object through the head-mounted display. A second user may also be looking at the first object. The second user may be using a second head-mounted display, or could alternately be connected to the head-mounted display and be looking at the first object via a video feed from the head-mounted display of the first user.

The communication device initiates (407) a call with the intended call recipient. This call can be, for example, a PTT call on a two-way radio or a cellular call utilizing a mobile phone or the like.

In accordance with the foregoing, an improved method, device, and system for completing a call utilizing a head-mounted display and a communication device is disclosed. As a result of the foregoing, a user of the communication device is able to complete calls in less time than current communication systems because the user does not need to key in the phone number of an intended call recipient. Further, the user does not need to divert his or her gaze from an emergency situation to look at the communication device in order to select an intended call recipient. In addition, more accurate communications are made because a user can identify a call recipient using vision and not by entering numbers on a keypad, which can be greatly beneficial in stressful situations, and in particular in situations when a communication device may not be easily visible or the keys on a communication device are difficult to accurately depress.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for completing a call utilizing a head-mounted display and a communication device, the method comprising:
detecting a call-initiating event at the communication device;
identifying, in response to the call-initiating event, an intended call recipient utilizing the head-mounted display; and
initiating a call with the intended call recipient utilizing the communication device.

2. The method of claim 1, wherein the step of detecting a call-initiating event at the communication device comprises detecting a pressing of a call button on the communication device.

3. The method of claim 2, wherein the call button is a Push-To-Talk (PTT) button.

4. The method of claim 2, wherein the call button is a dial button on a mobile phone.

5. The method of claim 1, wherein the step of detecting a call-initiating event at the communication device comprises detecting a predefined gesture.

6. The method of claim 5, wherein the step of detecting a predefined gesture comprises detecting a predefined gesture utilizing the head-mounted display.

7. The method of claim 1, wherein the step of detecting a call-initiating event at the communication device comprises detecting a predefined object.

8. The method of claim 7, wherein the step of detecting a predefined object comprises detecting a predefined object utilizing the head-mounted display.

9. The method of claim 1, wherein the step of identifying an intended call recipient utilizing the head-mounted display comprises determining an avatar that a user of the head-mounted display is looking at, wherein the avatar is associated with a person.

10. The method of claim 1, wherein the step of identifying an intended call recipient utilizing the head-mounted display comprises determining who a user of the head-mounted display is looking at.

11. The method of claim 1, wherein the step of identifying an intended call recipient utilizing the head-mounted display comprises:
determining an object that a user of the head-mounted display is looking at utilizing the head-mounted display;
determining a second user who is looking at the object; and
identifying the second user as the intended call recipient.

12. The method of claim 11, wherein the second user is looking at the object utilizing a second head-mounted display.

13. The method of claim 11, wherein the user is looking at the object via a video feed from the head-mounted display of the second user.

14. The method of claim 1, wherein the step of initiating a call with the intended call recipient utilizing the communication device comprises initiating a call with the intended call recipient utilizing a mobile radio.

15. A communication system comprising:
a head-mounted display for identifying an intended call recipient; and
a communication device operably coupled to the head-mounted display and including a call button for initiating a call with the intended call recipient.

16. The communication system of claim 15, wherein the communication system further comprises a gesture recognition module capable of detecting a gesture made by a user of the communication system.

17. The communication system of claim 15, wherein the communication system further comprises an object recognition module capable of detecting a predefined object.

18. The communication system of claim 15, wherein the head-mounted display is capable of identifying an intended call recipient by determining who a user of the head-mounted display is looking at.

19. The communication system of claim 15, wherein the head-mounted display is capable of identifying an intended call recipient by determining an object that a user of the head-mounted display is looking at, and further by determining that the intended call recipient is looking at the object.

20. A non-transitory computer readable media storing instructions that, when executed by a processor, perform a set of functions for completing a call utilizing a head-mounted display and a communication device, the set of functions comprising:
detecting a call-initiating event at the communication device;
identifying, in response to the call-initiating event, an intended call recipient utilizing the head-mounted display; and
initiating a call with the intended call recipient utilizing the communication device.
